(19) United States
(12) Patent Application Publication
(10) Pub. No.: US 2013/0241495 A1
(43) Pub. Date: Sep. 19, 2013

(54) ENERGY STORAGE SYSTEM AND METHOD OF CONTROLLING THE SAME

(71) Applicant: Byeong-Seon MIN, Yongin-si (KR)

(72) Inventor: Byeong-Seon MIN, Yongin-si (KR)

(73) Assignee: SAMSUNG SDI CO., LTD., Yongin-si (KR)

(21) Appl. No.: 13/564,296

(22) Filed: Aug. 1, 2012

(30) Foreign Application Priority Data
Mar. 15, 2012 (KR) 10-2012-0026603

(51) Int. Cl. H02J 7/00

(52) U.S. Cl. 320/134

(57) ABSTRACT

An energy storage system and a method of controlling the energy storage system. The energy storage system includes a bidirectional inverter for outputting generation power of the power generation system and power of a battery to the grid, and an integrated controller for controlling an output power of the bidirectional inverter by using predicted generation power of the power generation system calculated based on weather such that charging or discharging of the battery is conducted while maintaining an allowable range of remaining battery capacity.

### CLAIM OF PRIORITY

This application makes reference to, incorporates the same herein, and claims all benefits accruing under 35 U.S.C. §119 from an application earlier filed in the Korean Intellectual Property Office on the 15 Mar. 2012 and there duly assigned Serial No. 10-2012-0026603.

### BACKGROUND OF THE INVENTION

1. Field of the Invention

One or more embodiments of the present invention relate to an energy storage system and a method of controlling the same.

2. Description of the Related Art

Recently, the importance of new renewable energy has been recognized due to changes in domestic and foreign environments. In particular, solar energy generation systems which generate power by using solar energy from among new renewable energies are gaining attention due to the fact that it does not create pollution and installation and maintenance thereof is relatively easy. The solar light generation systems convert a direct current (DC) power which is generated from solar cells, into an alternating current (AC) power, and supply the converted power to a load in connection with a grid. If generation power of a solar cell is smaller than consumption power of the load, the power of the solar cell is consumed all in the load, and the grid supplies an insufficient amount. If generation power of a solar cell is greater than consumption power of the load, a remaining amount of the generation power of the solar cell is supplied to the grid as a reverse power flow.

Meanwhile, a power storage system stores a surplus power generated during the night time from the grid into an energy storage apparatus and uses the remaining power during the daytime. The power storage system suppresses a peak of the generation power during day and utilizes the night power. The power storage system uses a battery as an energy storage apparatus to thereby reduce space thereof, and thus may be installed in a typical container, and in the case of a power failure, power supply is possible from the battery.

An energy storage system is an integrated form of an energy generation system of a new renewable energy, represented here by solar energy, and a power storage system. The energy storage system may store new renewable energy and remaining power of a grid and may supply the same to a load, and may also stably supply power to the load in the case of a power failure.

The energy storage system includes a plurality of converters and inverters to convert generated energy into various levels of AC or DC power. That is, since power generated in the solar cell is DC power, in order to supply the DC power to an AC type power grid, a DC-AC inverter is required. An inverter has to stably supply power generated in the solar cell and power from a battery to a grid, and thus it is important to control an output of the inverter.

### SUMMARY OF THE INVENTION

One or more embodiments of the present invention include an energy storage system capable of stably supplying power generated in a power generation system and battery power to a load and/or a grid.

Additional aspects will be set forth in part in the description which follows and, in part, will be apparent from the description, or may be learned by practice of the presented embodiments.

According to one or more embodiments of the present invention, an energy storage system supplies power to a load, in connection with a power generation system, a battery, and a grid. The energy storage system includes a bidirectional inverter for outputting generation power of the power generation system and power of the battery to the grid, and an integrated controller for controlling an output power of the bidirectional inverter by using predicted generation power of the power generation system calculated based on weather such that charging or discharging of the battery is conducted while maintaining an allowable range of remaining battery capacity.

The integrated controller may include a weather predicting unit for predicting weather based on at least one weather parameter collected from a weather forecast, a generation amount database in which relationships between actual weather and an actual generation power of the power generation system are stored, and a generation amount predicting unit for calculating the predicted generation power based on the actual generation power by comparing the predicted weather with actual weather of the generation power amount database.

The weather predicting unit may calculate a gain based on a correlation between a weather parameter and generation power of the power generation system, and calculate a sum of multiplications of the at least one weather parameter and the gain to obtain the predicted weather.

The actual weather may be digitized values obtained by adding multiplications of at least one actual weather parameter by a gain.

The at least one weather parameter may include solar radiation, cloud amount, and temperature.

The energy storage system may further include a battery management unit that controls the battery to be charged or discharged in a range between a maximum remaining capacity and a minimum remaining capacity of the battery while a half of a difference between the maximum remaining capacity and the minimum remaining capacity is set as a basis.

The energy storage system may further include a power converting unit for converting a voltage output from the power generation system into a direct current (DC) link voltage, a bidirectional converter for converting an output voltage of the battery into the DC link voltage or vice versa, and a DC link unit maintaining a voltage level of the DC link voltage uniformly, wherein the bidirectional inverter converts the DC link voltage into an alternating current (AC) voltage of the grid, and converts the AC voltage of the grid into the DC link voltage.

The power generation system may include a solar light generation system including a solar cell array converting solar light energy into power.

According to one or more embodiments of the present invention, a method of controlling an energy storage system that supplies power to a load in connection with a power generation system, a battery, and a grid is provided. The method includes predicting generation power of the power generation system based on weather, and controlling an output of an inverter that outputs generation power of the power generation system and power of the battery to the grid by using the predicted generation power such that charging or discharging of the battery is conducted while maintaining an allowable range of remaining battery capacity.

The predicting of the generation power may include predicting weather based on at least one weather parameter collected from a weather forecast, and predicting generation power from an actual generation power by comparing the predicted weather with actual weather of a generation amount database in which relationships between the actual weather and the actual generation power of the power generation system are stored.

The predicting of the weather may include calculating a gain based on a correlation between a weather parameter and generation power of the power generation system, and calculating a sum of multiplications of at least one weather parameter by the gain to obtain the predicted weather.

### BRIEF DESCRIPTION OF THE DRAWINGS

These and/or other aspects will become apparent and more readily appreciated from the following description of the embodiments, taken in conjunction with the accompanying drawings of which:

FIG. 1 is a block diagram illustrating a grid-connected energy storage system constructed as an embodiment according to the principles of the present invention;

FIG. 2 is a detailed block diagram illustrating the grid-connected energy storage system constructed as an embodiment according to the principles of the present invention;

FIG. 3 is a diagram illustrating a relationship between an output power of a bidirectional inverter and a safe range of a state of charge (SOC) as an embodiment according to the principles of the present invention;

FIG. 4 is a schematic block diagram illustrating a configuration of an integrated controller constructed as an embodiment according to the principles of the present invention; and

FIG. 5 is a flowchart illustrating a method of controlling a bidirectional inverter as an embodiment according to the principles of the present invention.

### DETAILED DESCRIPTION OF THE INVENTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Regarding the like elements in the drawings, it should be noted that also when the elements are illustrated in different drawings, they are denoted by like reference numerals and symbols as much as possible. In the description of the present invention, certain detailed explanations of functions or configurations of related art are omitted when it is deemed that they may unnecessarily obscure the essence of the invention.

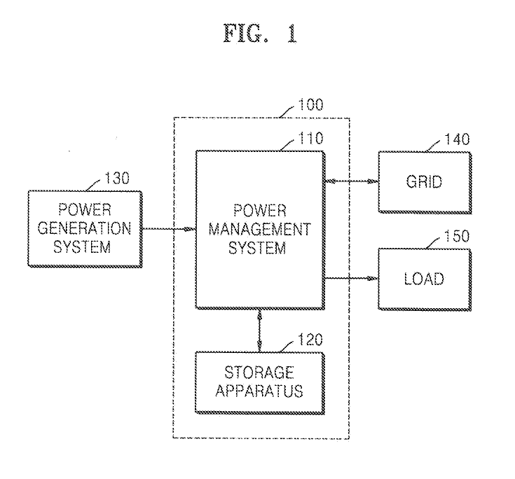

FIG. 1 is a block diagram of a grid-connected energy storage system 100 as an embodiment of the present invention.

Referring to FIG. 1, the grid-connected energy storage system 100 includes a power management system 110 and a storage apparatus 120. The grid-connected energy storage system 100 is used with a power generation system 130 and a grid 140 to supply power to a load 150.

The power management system 110 receives power generated in the power generation system 130 to transmit the same to the grid 140, store the same in the storage apparatus 120, or supply the same to the load 150. Here, the generated power may be a direct current (DC) power or an alternating current (AC) power.

The power management system 110 may store the power generated in the power generation system 130, in the storage apparatus 120, and supply the generated power to the grid 140. Also, the power management system 110 may transmit the power stored in the storage apparatus 120 to the grid 140 or store the power supplied from the grid 140 in the storage apparatus 120.

The power management system 110 may convert power in order to store the generated power in the storage apparatus 120, to supply the power to the grid 140 or the load 150, to store the power of the grid 140 in the storage apparatus 120, or to supply the power stored in the storage apparatus 120 to the grid 140 or the load 150. Also, the power management system 110 may monitor states of the storage apparatus 120, the grid 140, and the load 150 and distribute the power generated in the power generation system 130 or the power supplied from grid 140 based on the monitored states. Also, in an abnormal situation, for example, if there is a power failure in the grid 140, the power management system 110 may supply the power to the load 150 by performing an uninterruptible power supply (UPS) operation. Even if the grid 140 is in a normal state, the power management system 110 may supply power generated by the power generation system 130 or power stored in the storage apparatus 120 to the load 150.

The storage apparatus 120 is a large-capacity storage apparatus that stores the power supplied from the power management system 110. Here, the supplied power may be the power converted from the power generated by the power generation system 130 or the power converter from common-use power supplied from the grid 140. The power stored in the storage apparatus 120 may be supplied to the grid 140 according to control of the power management system 110 or may be supplied to the load 150.

The power generation system 130 is a system that generates power by using an energy source. The power generation system 130 generates power and supplies the power to the energy storage system 100. The power generation system 130 may be a solar power generation system, a wind power generation system, or a tidal power generation system or any power generation system that may generate power by using renewable energy such as solar heat or geothermal heat. In particular, a solar cell for generating electrical energy by using sunlight is suitable for the grid-connected energy storage system 100, which may be distributed in houses and factories, due to its ease of installation.

The grid 140 includes a power generating station, an electric power substation, a power line, and the like. When the grid 140 is in a normal state, the grid 140 supplies power to the energy storage system 100 or the load 150 and receives power from the energy storage system 100. When the grid 140 is in an abnormal state, power supplied from the grid 140 to the energy storage system 100 or to the load 150 is stopped, and power supplied from the energy storage system 100 to the grid 140 is also stopped.

The load 150 consumes the power output from the storage apparatus 120 or the grid 140, and may be, for example, a house, a factory, or the like.

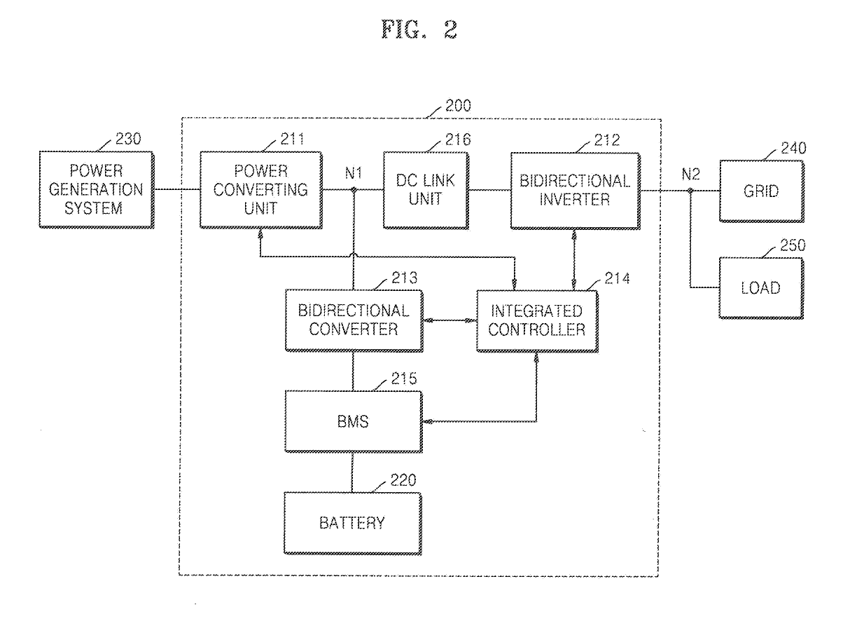

FIG. 2 is a detailed block diagram illustrating the grid-connected energy storage system as an embodiment of the present invention.

Referring to FIG. 2, the grid-connected energy storage system 200 (hereinafter referred to as a “energy storage system”) includes a power converting unit 211, a bidirectional inverter 212, a bidirectional converter 213, an integrated controller 214, a battery management system (BMS) 215, and a DC link unit 216. The power storage system 200 is connected to a power generation system 230, a grid 240, and a load 250.

The power converting unit 211 is connected between the power generation system 230 and a first node N1, and converts power generated in the power generation system 230 and transmits the converted power to the first node N1. The generated power may be DC power or AC power, and accordingly, the power converting unit 211 may perform rectification by which AC power is converted into DC power or may perform a function of a converter converting DC power from one voltage level to another.

For example, the power converting unit 211 converts a voltage output from the power generation system 230 into a DC voltage of the first node N1. An operation of the power converting unit 211 may vary according to a type of the power generation system 230. If the power generation system 230 is a wind power generation system or a tidal power generation system that outputs an AC voltage, the power converting unit 211 rectifies the AC voltage of the power generation system 230 into a DC voltage of the first node N1. If the power generation system 230 is, for example, a solar cell that outputs a DC voltage, the power converting unit 211 converts the DC voltage of the power generation system 230 into a DC voltage of the first node N1. For example, if the power generation system 230 is a solar cell, the power converting unit 211 may convert a DC voltage output from the solar cell into a DC voltage of the first node N1, and may be a maximum power point tracking (MPPT) converter that tracks a maximum power output voltage according to a change in solar radiation, temperature, or the like. A MPPT converter performs two functions, one of a boost DC-DC converter of raising an output DC voltage of a solar cell to thereby output a DC voltage and one of performing MPPT control.

The DC link unit 216 is connected between the first node N1 and the bidirectional inverter 212 to maintain a DC voltage level of the first node N1 at a DC link level. A voltage level of the first node N1 may become instable due to an instantaneous voltage drop in the power system 230 or the grid 240 or a peak load generated in the load 250 or the like. However, the voltage of the first node N1 has to be stabilized to conduct a normal operation of the bidirectional converter 213 or the bidirectional inverter 212. The DC link unit 216 may be included to stabilize the DC voltage level of the first node N1, and may be, for example, a capacitor. As the capacitor, for example, an aluminum electrolytic capacitor, a high-pressure film capacitor (polymer capacitor), or a multi-layer ceramic capacitor (MLCC) for high pressure and large current, may be used. While the DC link unit 216 is separately included in the current embodiment of the present invention, the DC link unit 216 may instead be included in the bidirectional converter 213, the bidirectional inverter 212, or the power converting unit 211.

The bidirectional inverter 212 is a power converter connected between the first node N1 and the grid 240. The bidirectional inverter 212 may convert a DC power output from the power converting unit 211 into an AC power of the power grid 240, or a DC power output from the bidirectional converter 213 into an AC power of the power grid 240. Also, the bidirectional inverter 212 may convert common-use AC power supplied from the power grid 240 into DC power and transmit the same to the first node N1. In addition, the bidirectional inverter 212 controls a conversion efficiency according to control of the integrated controller 214.

For example, the bidirectional inverter 212 rectifies and outputs an AC voltage received from the grid 240 into a DC voltage so as to store the same in the battery 220. Also, the bidirectional inverter 212 converts and outputs a DC voltage output from the power generation system 230 or the battery 220 into an AC voltage of the grid 240. In addition, the bidirectional inverter 212 may include a filter for removing harmonics from the AC voltage output to the grid 240, and may perform other functions such as restriction of a voltage variation range, power factor correction, removal of DC components, and preventing of a transient phenomenon.

The bidirectional converter 213 is a power converter connected between the first node N1 and the battery 220. The bidirectional converter 213 converts DC power supplied via the first node N1 to DC power of a different voltage level, and transmits the same to the battery 220. Also, the bidirectional converter 213 converts the DC power stored in the battery 220 into DC power of a different voltage level, and transmits the same to the first node N1. Also, the bidirectional converter 213 controls a conversion efficiency according to control by the integrated controller 214.

For example, the bidirectional converter 213 may convert a DC link voltage of the first node N1 into a DC voltage so as to be stored in the battery 220, and the DC voltage stored in the battery 220 into a DC link voltage level to be transmitted to the first node N1. For example, the bidirectional converter 213 functions as a buck converter that reduces a DC link voltage level of the first node N1 to a battery storage voltage when charging DC power generated in the power generation system 230 in the battery 220 or when charging AC power supplied from the grid 240 in the battery 220. In addition, when supplying the power charged in the battery 220 to the grid 240 or the load 250, the bidirectional converter 213 functions as a boost converter that raises a battery storage voltage to a DC link voltage level of the first node N1.

The battery 220 stores power supplied from the power generation system 230 or the grid 240. The battery 220 discharges the stored power, and may have a structure in which battery cells are connected serially or in parallel in order to increase capacity and output of the battery 220. The battery 220 may be any of various types of battery cells, and may be, for example, a nickel-cadmium battery, a lead storage battery, a nickel metal hydride (NiMH) battery, a lithium ion battery, a lithium polymer battery, and the like. The number of the batteries 220 may be determined according to power capacity required for the power management system 110, design conditions of the power management system 110, or the like.

The BMS 215 is connected to the battery 220 and controls charging and discharging-operations of the battery 220 according to control by the integrated controller 214. A discharging current from the battery 220 to the bidirectional converter 213 or a charging current from the bidirectional converter 213 to the battery 220 is transmitted via the BMS 215. Also, to protect the battery 220, the BMS 215 may perform overcharge protection, over-discharge protection, over-current protection, overvoltage protection, overheat protection, cell balancing, etc. To this end, the BMS 215 may monitor a voltage, current, temperature, a remaining amount of power, lifetime, etc. of the battery 220, and transmit relevant information to the integrated controller 214. While the BMS 215 is separately included from the battery 220, the BMS 215 and the battery 220 may also be integrated as a battery pack.

The integrated controller 214 monitors states of the power generation system 230 and the grid 240 to control operations of the BMS 215, the bidirectional converter 213, the bidirectional inverter 212, and the power converting unit 211. The integrated controller 214 controls an output power of the bidirectional inverter 212 such that a remaining battery capacity, that is, a state of charge (SoC), of the battery 220 is maintained within a safe range. According to a connection method between the power generation system 230 and the battery 220, the bidirectional inverter 212 stably outputs an unstable energy source of the power generation system 230 via the battery 220. Here, by controlling an output power of the bidirectional inverter 212, the battery 220 may be stably operated. The integrated controller 214 uniformly controls an output power of the bidirectional inverter 212 so that charging or discharging of the battery 220 is conducted within a safe range of a SoC.

Hereinafter, a solar power generation system including a solar cell array converting solar energy into power will be described as the power generation system 230. However, the embodiments of the present invention may also be applied to other power generation systems.

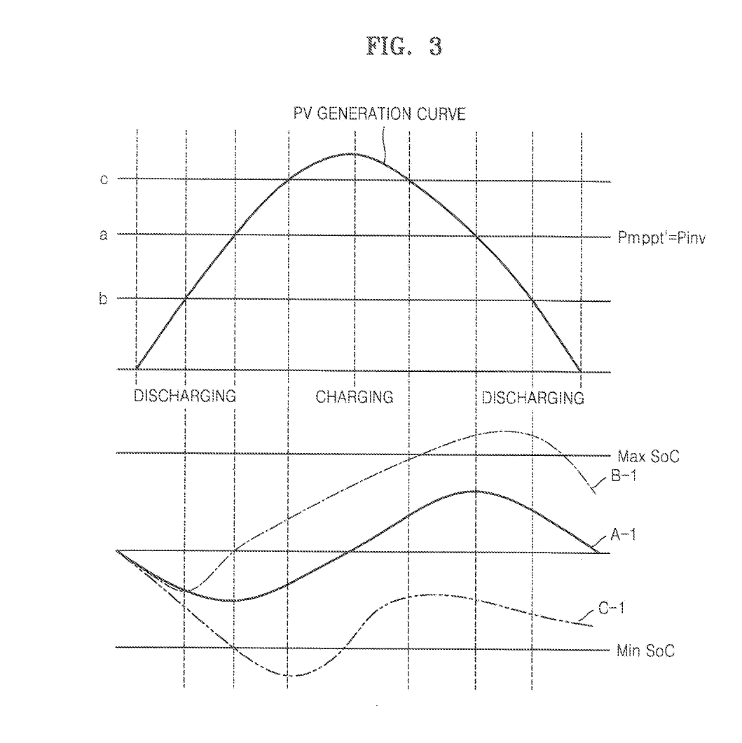

FIG. 3 is a diagram illustrating a relationship between an output power of a bidirectional inverter and a safe range of a state of charge (SoC) as an embodiment of the present invention.

Referring to FIG. 3 along with FIG. 2, an output power Pinv of the bidirectional inverter 212 (hereinafter, “inverter output power”) is a sum of generation power Pmppt of the power generation system 230 output via the power converting unit 211 and battery power Pbat of the battery 220 output via the bidirectional converter 213. The battery power Pbat is expressed as a positive (+) value when discharging, and as a negative (−) value when charging.

Pinv=Pmppt+Pbat (1)

When looking at a daily total generation amount, referring to Equation (1), if the inverter output power Pinv is set the same as the generation power Pmppt, the battery output power Pbat is 0. Accordingly, by predicting the generation power Pmppt and maintaining the inverter output power Pinv as the predicted generation power Pmppt′, the SoC of the battery may be maintained within a safe range. This is shown in FIG. 3.

FIG. 3 illustrates a change of the inverter output power Pinv and a SOC of a battery. A curve of a photovoltaic (PV) generation shows a total daily generation of solar light. ‘a’ denotes predicted generation power Pmppt′.

When the inverter output power Pinv is set as ‘a’, charging or discharging is conducted while SOC is varied in a sinusoidal form with respect to an initial SoC as a curve A-1. The initial SOC is half of an allowed range of the SoC as given by Equation (2) below.

Initial SoC=(maximum SoC(Max SoC)−minimum SoC (Min SoC))/2 (2)

However, when the inverter output power Pinv is set as ‘b’ or ‘c’, the SoC deviates from Max SoC or Min SoC like a curve B-1 or C-1. When SoC approaches Max SoC or Min SoC, accuracy of SoC is decreased.

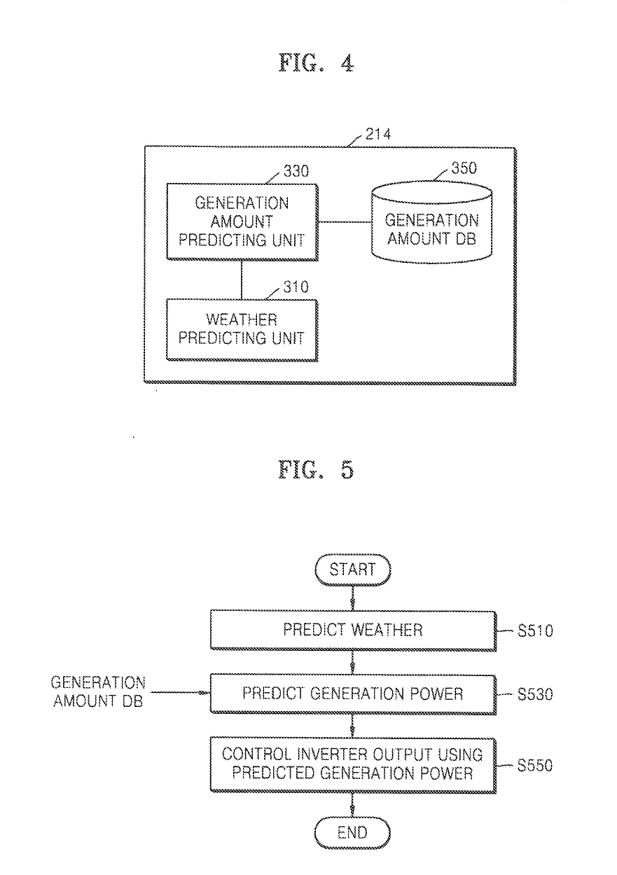

FIG. 4 is a schematic block diagram illustrating a configuration of the integrated controller 214 as an embodiment of the present invention; and

Referring to FIG. 4, the integrated controller 214 may include a weather predicting unit 310, a generation power predicting unit 330, and a generation amount database 350.

The weather predicting unit 310 defines at least one weather parameter, and calculates a gain of each weather parameter based on a correlation between the at least one weather parameter and generation power of each of the weather parameters. The weather predicting unit 310 normalizes the at least one weather parameter, and multiplies the normalized at least one weather parameter by a corresponding gain to thereby calculate a result of weather prediction. The weather parameter may comprise solar radiation, cloud amount, or temperature, but the embodiments of the present invention are not limited thereto, and other various weather parameters may be used. The weather parameters may be obtained based on a regional weather forecast.

Result of weather prediction=Ax+By+Cz+ (3)

Here, A, B, and C may be weather parameters, and x, y, and z may be gains corresponding to the weather parameters.

The weather predicting unit 310 may divide a daily unit or a day into predetermined time units according to a set standard and calculate weather prediction results of each of the time units by digitizing the same.

The generation power predicting unit 330 calculates predicted generation power based on actual generation power corresponding to actual weather of the generation amount database 350 which matches the weather prediction results. The generation power predicting unit 330 may calculate predicted generation power using an average interpolation method if there is no actual weather that matches. The generation power predicting unit 330 may divide the daily unit or day into predetermined time units according to a set standard and calculate weather prediction results of each of the time units by digitizing the same.

The generation amount database 350 stores relationships between actual weather and actual generation power of the power generation system according to a date and/or period. The actual weather refers to values obtained by digitizing weather according to corresponding dates and/or periods by performing the same calculation as the weather prediction calculation. The actual weather are digitized values calculated by a sum of multiplications of each of actual weather parameters such as actual solar radiation, cloud amount, or temperature by set gains. The relationships between the actual weather and the actual generation power of the power generation system are recorded in a lookup table or shown on a graph to construct a database.

Table 1 below shows examples of relationships between date, actual weather, and actual generation power stored in the generation amount database 350. Using the values of actual weather and actual generation power of Table 1, when a weather prediction result of 5.8 is calculated, predicted generation power of 11.6 kWh may be calculated.

TABLE 1

| Date | Actual weather | Actual generation power (kWh) |
|---|---|---|
| May 16 | 9.75 | 19.5 |
| May 17 | 9.6 | 19.2 |
| May 18 | 7.715 | 15.43 |
| May 20 | 2.255 | 4.51 |
| May 24 | 8.155 | 16.31 |
| May 25 | 5.065 | 10.13 |
| May 26 | 1.935 | 3.87 |
| May 27 | 3.96 | 7.92 |
| May 30 | 7.165 | 14.33 |
| May 31 | 3.645 | 7.29 |
| June 02 | 2.79 | 5.58 |
| June 03 | 9.575 | 19.15 |
| June 07 | 7.935 | 15.87 |
| June 08 | 8.65 | 17.3 |
| June 09 | 5.305 | 10.61 |
| June 10 | 3.695 | 7.39 |
| June 14 | 6.6 | 13.2 |
| June 16 | 9.025 | 18.05 |
| June 20 | 8.55 | 17.1 |
| June 21 | 7.825 | 15.65 |
| June 22 | 3.45 | 6.9 |
| June 23 | 0.865 | 1.73 |
| June 27 | 1.45 | 2.9 |
| June 29 | 1.925 | 3.85 |
| July 01 | 4.66 | 9.32 |
| July 05 | 8.175 | 16.35 |
| July 08 | 1.34 | 2.68 |
| July 15 | 3.16 | 6.32 |
| July 18 | 8.6 | 17.2 |
| July 20 | 9.02 | 18.04 |
| July 22 | 2.445 | 4.89 |

The integrated controller 214 controls an inverter output power Pinv of the bidirectional inverter 212 using the predicted generation power. As the inverter output power Pinv of the bidirectional inverter 212 is controlled to a uniform value, charging or discharging of the battery 220, in other words, the SoC thereof, may be controlled in a safe range within a SoC allowable range. The integrated controller 214 may adjust calculation time units of weather prediction or generation power prediction according to, for example, a whole day, a.m./p.m., 8-hour units, etc.

FIG. 5 is a flowchart illustrating a method of controlling an energy storage system as an embodiment of the present invention.

The energy storage system according to the current embodiment of the present invention supplies power to a load in connection with a power generation system, a battery, and a grid, and controls an output of a bidirectional inverter. Here, a solar power generation system including a solar cell array which converts sunlight into power will be described as an example of the energy storage system.

As output characteristics of solar energy vary greatly according to weather, the energy storage system according to the current embodiment of the present invention may stably output power to a grid and/or a load via a battery. Here, output control of an inverter outputting generation power of a power generation system and power of a battery to a grid is the core of real-time power trade, and how to control output of an inverter is directly related to operation of a battery. According to the embodiments of the present invention, by controlling an output of an inverter by using predicted generation power of the power generation system calculated based on weather, a SoC of the battery is maintained within a safe range.

Referring to FIG. 5, in operation S510, the energy storage system collects weather information from a regional weather forecast to predict weather. The energy storage system normalizes at least one weather parameter according to set time units, and multiplies the normalized at least one weather parameter by a gain and calculates a weighted sum of such multiplications, and calculates the digitized values as weather prediction results. The gain is calculated based on a correlation between the weather parameter and generation power of the power generation system.

In operation S530, the energy storage system compares the weather prediction results with actual weather of the generation amount database to look for matching weather, and calculates a predicted generation power from the actual generation power corresponding to the matching actual weather. The generation amount database obtains and stores in advance lookup tables or graphs in which the relationships between the actual weather and the actual generation power of the power generation system are recorded. The actual weather is expressed by digitized values that are obtained as a sum of multiplications of at least one weather parameter and a gain. The gain is calculated based on a correlation between the weather parameter and generation power of the power generation system. The weather parameter and the gain used in weather prediction are the same as the weather parameter and the gain used in expressing the actual weather of the generation amount database. The generation amount database may be constructed according to a date or time. The energy storage system may calculate predicted generation power by applying an interpolation method to data of a generation power database.

In operation S550, the energy storage system controls an inverter output power using a predicted generation power. By uniformly controlling an inverter output by setting the predicted generation power as an inverter output, charging or discharging of a battery is conducted within a safe range of a SoC allowable range. Accordingly, power may also be stably output to a grid and/or a load of the energy storage system.

According to an energy system of an embodiment of the present invention, power conversion may be performed in both directions between a storage apparatus including a battery and a power grid or a load, and power generated in a generation system may be supplied to the load, the grid, or the storage apparatus.

According to an energy storage system of an embodiment of the present invention, by controlling an output power of an inverter uniformly, charging or discharging of a battery is conducted within a safe range of a state of charge (SoC), which is a remaining battery capacity, and power may be supplied according to demand and thus power trade is allowed, and the energy storage system may be stabilized.

While the exemplary embodiments of the invention have been particularly shown and described, it will be understood by those of ordinary skill in the art that various changes in form and details may be made therein without departing from the spirit and scope of the embodiments of invention as defined by the appended claims. The exemplary embodiments should be considered in descriptive sense only and not for purposes of limitation. Therefore, the scope of the embodiments of invention is defined not by the detailed description of the embodiments of invention but by the appended claims, and all differences within the scope will be construed as being included in the embodiments of the present invention.

What is claimed is:

1. An energy storage system supplying power to a load, in connection with a power generation system, a battery, and a grid, the energy storage system comprising:
a bidirectional inverter for outputting generation power of the power generation system and power of the battery to the grid; and
an integrated controller for controlling an output power of the bidirectional inverter by using predicted generation power of the power generation system calculated based on weather such that charging or discharging of the battery is conducted while maintaining an allowable range of remaining battery capacity.

2. The energy storage system of claim 1, wherein the integrated controller comprises:
a weather predicting unit for predicting weather based on at least one weather parameter collected from a weather forecast;
a generation amount database in which relationships between actual weather and an actual generation power of the power generation system are stored; and
a generation amount predicting unit for calculating the predicted generation power based on the actual generation power by comparing the predicted weather with actual weather of the generation amount database.

3. The energy storage system of claim 2, wherein the weather predicting unit calculates a gain based on a correlation between a weather parameter and generation power of the power generation system, and calculates a sum of multiplications of the at least one weather parameter and the gain to obtain the predicted weather.

4. The energy storage system of claim 2, wherein the actual weather is expressed as digitized values obtained by adding multiplications of at least one actual weather parameter by a gain.

5. The energy storage system of claim 2, wherein the at least one weather parameter comprises solar radiation, cloud amount, and temperature.

6. The energy storage system of claim 1, further comprising a battery management unit that controls the battery to be charged or discharged in a range between a maximum remaining capacity and a minimum remaining capacity of the battery while a half of a difference between the maximum remaining capacity and the minimum remaining capacity is set as a basis.

7. The energy storage system of claim 1, further comprising:
a power converting unit for converting a voltage output from the power generation system into a direct current (DC) link voltage;
a bidirectional converter for converting an output voltage of the battery into the DC link voltage or vice versa; and
a DC link unit maintaining a voltage level of the DC link voltage uniformly,
wherein the bidirectional inverter converts the DC link voltage into an alternating current (AC) voltage of the grid, and converts the AC voltage of the grid into the DC link voltage.

8. The energy storage system of claim 1, wherein the power generation system comprises a solar light generation system including a solar cell array converting solar light energy into power.

9. A method of controlling an energy storage system that supplies power to a load in connection with a power generation system, a battery, and a grid, the method comprising:
predicting generation power of the power generation system based on weather; and
controlling an output of an inverter that outputs generation power of the power generation system and power of the battery to the grid by using the predicted generation power such that charging or discharging of the battery is conducted while maintaining an allowable range of remaining battery capacity.

10. The method of claim 9, wherein the predicting of the generation power comprises:
predicting weather based on at least one weather parameter collected from a weather forecast; and
predicting generation power from an actual generation power by comparing the predicted weather with actual weather of a generation amount database in which relationships between the actual weather and the actual generation power of the power generation system are stored.

11. The method of claim 10, wherein the predicting of the weather comprises:
calculating a gain based on a correlation between a weather parameter and generation power of the power generation system; and
calculating a sum of multiplications of at least one weather parameter by the gain to obtain the predicted weather.

12. The method of claim 10, wherein the actual weather is expressed as digitized values that are obtained by adding multiplications of the at least one weather parameter by a gain.

13. The method of claim 10, wherein the weather parameter comprises solar radiation, cloud amount, and temperature.

14. The method of claim 9, wherein the battery is controlled to be charged or discharged in a range between a maximum remaining capacity and a minimum remaining capacity of the battery while a half of a difference between the maximum remaining capacity and the minimum remaining capacity is set as a basis.

15. The method of claim 9, wherein the power generation system comprises a solar power generation system including a solar cell array for converting solar light energy into power.
